(19) United States
(12) Patent Application Publication
(10) Pub. No.: US 2008/0282934 A1
(43) Pub. Date: Nov. 20, 2008

(54) Method For Preparation Of Environmental Protection Waterproof Emulsion Paint

(76) Inventor: Kuo Min Chung, Shen Zhen (CN)

Correspondence Address: RABIN & Berdo, PC, 1101 14TH STREET, NW, SUITE 500, WASHINGTON, DC, 20005, US

(21) Appl. No.: 11/749,238

(22) Filed: May 16, 2007

(51) Int. Cl. C09D 5/02

(52) U.S. Cl. 106/287.1

(57) ABSTRACT

The invention relates to a chemically modified high molecular mixture for surface-painting on a plastic substrate, which consists of polyurethane emulsion, ionic type silicone solution, and ion exchange water, and to a method for preparation of the mixture comprising the steps of: (1) providing from about 40% to about 60% by weight of polyurethane emulsion, from about 30% to about 40% by weight of ionic type silicone solution, and from about 10% to about 25% by weight of ion exchange water; (2) adding sequentially the materials of step (1) into a stainless steel container; (3) stirring the materials in the container at a high speed of 3500-4500 rpm/min for 30 to 60 minutes to form a mixture; and (4) sieving the mixture via a 250 mesh sieve. The chemically modified high molecular mixture has advantages including no re-sticking, easy drying and high resistance to water, rubbing, solvent, and yellowing.

### FIELD OF THE INVENTION

The present invention relates to a chemically modified high molecular mixture for surface-painting on a plastic substrate.

### BACKGROUND OF THE INVENTION

Ethylene/vinyl acetate copolymer (EVA) is mainly used as an emulsion for this kind of materials commonly available in the market. A paint made through such an emulsion suffers from common problems of re-sticking and difficult-drying in the case of large delivery.

### SUMMARY OF THE INVENTION

It is an object of the present invention to provide a method for preparation of an environmental protection waterproof emulsion paint which has the features of no re-sticking and easy drying, even in the case of large delivery.

The emulsion paint in accordance with the invention consists of polyurethane emulsion, ionic type silicone solution, and ion exchange water. The method for preparation of the emulsion paint comprises the steps of:

(1) providing from about 40% to about 60% by weight of polyurethane emulsion, from about 30% to about 40% by weight of ionic type silicone solution, and from about 10% to about 25% by weight of ion exchange water;

(2) adding sequentially the materials of step (1) into a stainless steel container;

(3) stirring the materials in the container at a high speed of 3500-4500 rpm/min for 30 to 60 minutes to form a mixture; and

(4) sieving the mixture via a 250 mesh sieve to obtain the emulsion paint.

The polyurethane emulsion may be a denatured polyurethane emulsion, such as cross-linking polyurethane water emulsion, polyurethane filming agent or other denatured polyurethane emulsions.

The ionic type silicone solution may be a cationic type silicone solution or an anionic type silicone solution.

The product prepared through the method of the invention may be specifically used for substrate modification in the areas of digital printing, lithographic printing, relief printing and offset printing. Said product has advantages of no re-sticking, easy drying, bright color, fine and high-quality film, long life of use, and high resistance to water, rubbing, solvent, and yellowing.

### DETAILED DESCRIPTION OF THE INVENTION

1. Preparation of “High Glossiness Type” Product

The method for preparation of the title product comprises the following steps:

(1) providing about 50% by weight of denatured polyurethane emulsion, about 35% by weight of anionic type silicone solution, and about 15% by weight of ion exchange water;

(2) adding sequentially the materials of step (1) into a stainless steel container;

(3) stirring the materials in the container at a high speed of 4000 rpm/min for 30 minutes to form a mixture; and

(4) sieving the mixture via a 250 mesh sieve to obtain the title product which has 35%±2% of solid contents and 700-800 cps viscosity.

2. Preparation of “Sub-Glossiness Type” Product

The method for preparation of the title product comprises the following steps:

(1) providing about 45% by weight of denatured polyurethane emulsion, about 30% by weight of anionic type silicone solution, and about 25% by weight of ion exchange water;

(2) adding sequentially the materials of step (1) into a stainless steel container;

(3) stirring the materials in the container at a high speed of 3800 rpm/min for 60 minutes to form a mixture; and

(4) sieving the mixture via a 250 mesh sieve to obtain the title product which has 35%±2% of solid contents and 1000-1200 cps viscosity.

Numerous variations and modifications are easily obtainable by means of the skilled person's common knowledge without departing from the scope of the invention, however, such variations and modifications should fall into the scope of this invention.

What is claimed is:

1. A method for preparation of an environmental protection waterproof emulsion paint, which consists of polyurethane emulsion, ionic type silicone solution, and ion exchange water, said method comprising the steps of:
(1) providing from about 40% to about 60% by weight of polyurethane emulsion, from about 30% to about 40% by weight of ionic type silicone solution, and from about 10% to about 25% by weight of ion exchange water;
(2) adding sequentially the materials of step (1) into a stainless steel container;
(3) stirring the materials in the container at a high speed of 3500-4500 rpm/min for 30 to 60 minutes to form a mixture; and
(4) sieving the mixture via a 250 mesh sieve.

2. The method as claimed in claim 1, wherein the polyurethane emulsion is a denatured polyurethane emulsion.

3. The method as claimed in claim 2, wherein the denatured polyurethane emulsion is selected from cross-linking polyurethane water emulsion, polyurethane filming agent or other denatured polyurethane emulsions.

4. The method as claimed in claim 1, wherein the ionic type silicone solution is a cationic type silicone solution or an anionic type silicone solution.
